(19) United States
(12) Patent Application Publication
(10) Pub. No.: US 2018/0065541 A1
(43) Pub. Date: Mar. 8, 2018

(54) AERIAL LIGHT PROJECTION SYSTEM FOR LOCATING A MOTOR VEHICLE

(71) Applicant: FORD GLOBAL TECHNOLOGIES, LLC, Dearborn, MI (US)

(72) Inventor: Andrew John Augusty, Royal Oak, MI (US)

(21) Appl. No.: 15/257,577

(22) Filed: Sep. 6, 2016

(51) Int. Cl. B60Q 1/26; G08B 5/36

(52) U.S. Cl. CPC B60Q 1/26; G08B 5/36

(57) ABSTRACT

An aerial light projection system is provided for locating a motor vehicle. That system includes a light projector configured to project a light beam above the motor vehicle, a transmitting device for transmitting an operator identification signal specific to the motor vehicle, and a controller configured to activate the light projector when an operator of the motor vehicle is within a predetermined proximity of the motor vehicle as indicated by receipt of the operator identification signal specific to the motor vehicle. A related method is also disclosed.

### TECHNICAL FIELD

This document relates generally to the motor vehicle equipment field and, more particularly, to an aerial light projection system specifically adapted for locating a motor vehicle.

### BACKGROUND

In certain situations it can be very difficult for an individual to find their motor vehicle. This is particularly true in crowded, unfamiliar and dark parking areas. If the motor vehicle was not previously parked by the individual, the problem is compounded significantly. Thus, car sharing vehicles and rental vehicles can be particularly difficult to find.

This document relates to an aerial light projection system that is specifically adapted for locating a motor vehicle. That aerial light projection system also provides an interesting, unique, luxurious and welcoming display when an individual is searching for their motor vehicle.

### SUMMARY

In accordance with the purposes and benefits described herein, a system is provided for locating a motor vehicle. That system comprises: (a) a light projector configured to project a light beacon above the motor vehicle, (b) a transmitting device for transmitting an operator identification signal specific to the motor vehicle and (c) a controller. That controller is configured to activate the light projector when an operator of the motor vehicle is within a predetermined proximity of the motor vehicle as indicated by receipt of the operator identification signal specific to the motor vehicle.

The projected light beacon may take the shape of a particular symbol or even the shape of a company logo. The light beacon may be customized or individualized to a particular operator's desires.

The transmitting device may comprise a key fob for the motor vehicle. In one possible alternative embodiment, the transmitting device may comprise a cell phone carried by the individual or vehicle operator.

The controller may also be configured to activate the light projector when an actuator on the key fob, cell phone/mobile device, or otherwise connected electronic device is activated. That actuator could be a dedicated actuator for activating the light projector. That actuator could be a remote start actuator for the remote starting of the motor vehicle. That actuator could be a door unlock actuator for unlocking the doors of the motor vehicle. That actuator could be a door lock actuator for locking the doors of the motor vehicle.

In accordance with another aspect, the aerial light projection system for locating a motor vehicle may comprise: (a) a light projector configured to project a light beacon above the motor vehicle where that light beacon has a shape of a company logo and (b) a controller configured to operate the light projector.

In accordance with still another aspect, a method is provided of locating a motor vehicle. That method comprises the steps of sensing when an operator of the motor vehicle is within a predetermined proximity of the motor vehicle and activating, by a controller, a light projector when the operator is detected within the predetermined proximity of the motor vehicle.

The method may also include the step of projecting a light beacon above the motor vehicle when activated by the controller. Further, the method may include the step of projecting the light beacon in a form of a symbol. In another possible embodiment, the method may include the step of projecting the light beacon in the form of a company logo.

Still further, the method may include the step of sending, by a transmitting device carried by the operator, an operator identification signal specific to the motor vehicle. Further, the method may include sending the operator identification signal from a key fob for the motor vehicle. Alternatively, the method may include sending the operator identification signal from a cell phone of the operator. Still further, the method may include the step of configuring the controller to activate the light projector upon receiving the operator identification signal.

In the following description, there are shown and described several preferred embodiments of the aerial light projection system and the related method of locating a motor vehicle. As it should be realized, the system and method are capable of other, different embodiments and their several details are capable of modification in various, obvious aspects all without departing from the system and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the aerial light projection system and together with the description serve to explain certain principles thereof. In the drawing figures:

FIG. 1 is a schematic block diagram illustrating the aerial light projection system for locating a motor vehicle.

FIG. 2a is a perspective view illustrating a light beacon being projected onto the ceiling of a parking garage from a light projector mounted on a side mirror of a motor vehicle equipped with the aerial light projection system.

FIG. 2b is a perspective view of an alternative embodiment wherein the light projector is configured to project the holographic image of a company logo.

Reference will now be made in detail to the present preferred embodiments of the aerial light projection system and related method of locating a motor vehicle, examples of which are illustrated in the accompanying drawing figures.

### DETAILED DESCRIPTION

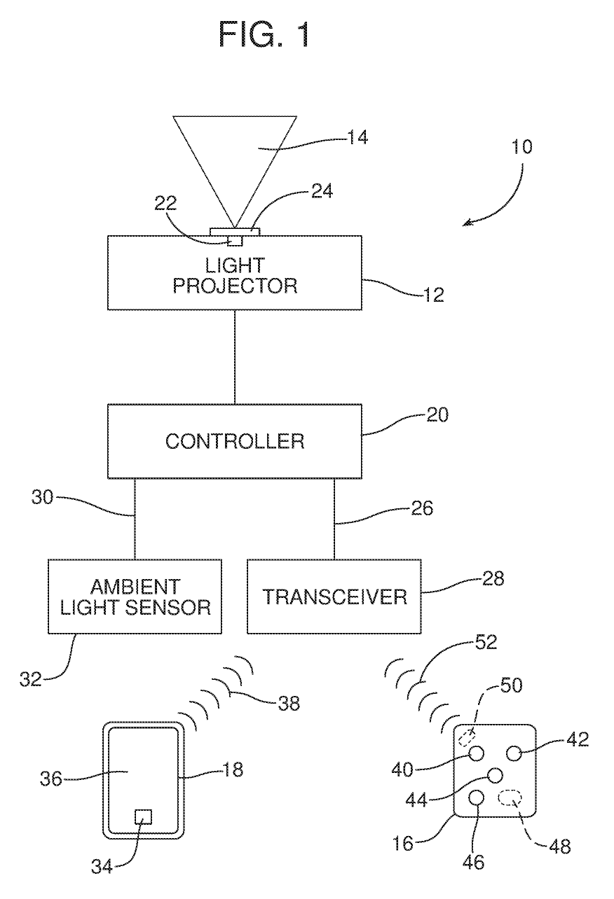

Reference is now made to FIG. 1 which schematically illustrates the aerial light projection system 10 for locating a motor vehicle V. That system 10 includes a light projector 12 configured to project a light beacon 14 above the motor vehicle V. In addition, the system includes a transmitting device such as the key fob 16 or the cell phone 18 for transmitting an operator identification signal specific to the motor vehicle V. Further, the system 10 includes a controller 20 configured to activate the light projector 12 when an authorized operator of the motor vehicle V is within a predetermined proximity of the motor vehicle as indicated by receipt of the operator identification signal specific to the motor vehicle.

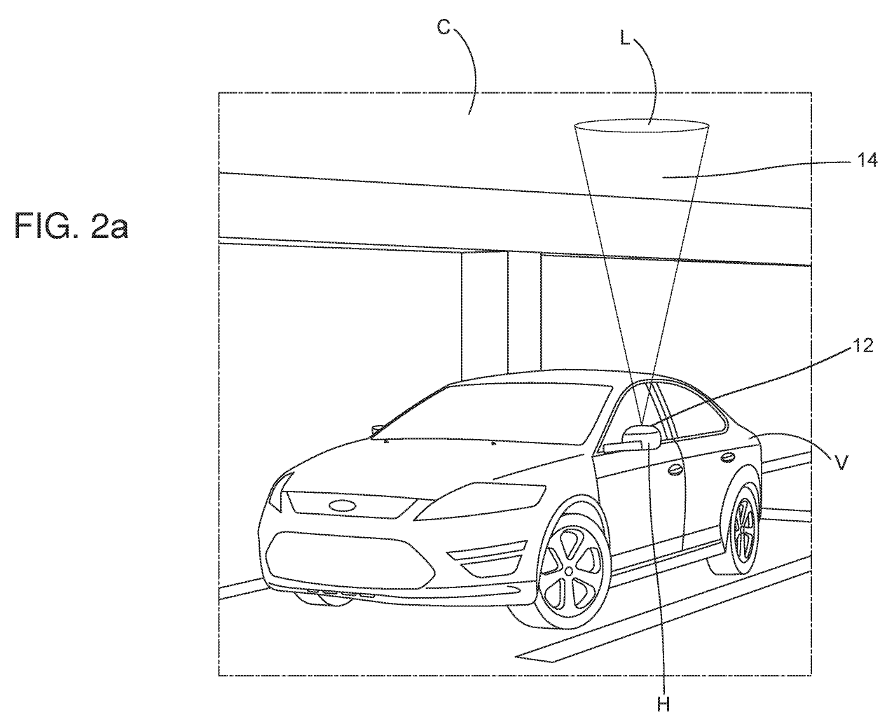

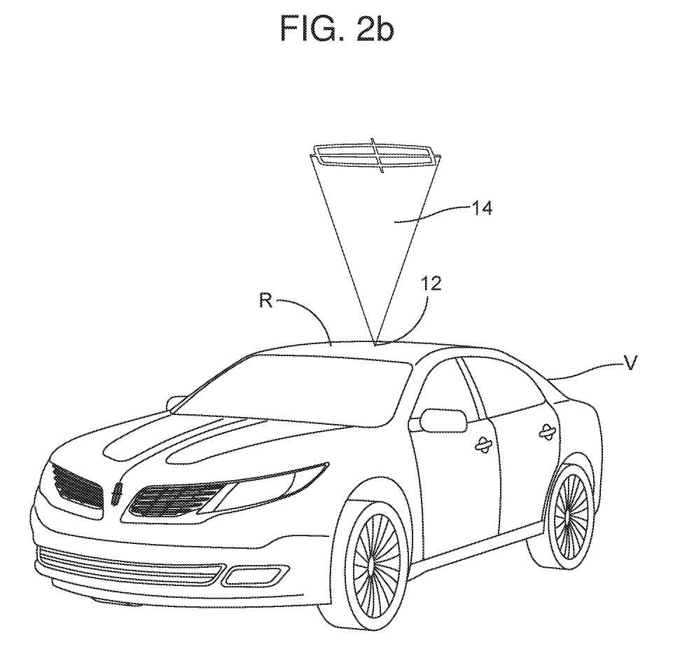

More specifically, the light projector 12 may comprise substantially any appropriate light source of a type useful for the intended purpose of locating the motor vehicle V. Thus, the light projector 12 may include a light emitting diode (LED) or standard, incandescent or fluorescent light. Alternatively, the light projector 12 may include a flood light, a strip light, an LED projector light or even a laser projector system for projecting a holographic image. Further, the light projector may include a filter 24 so that light from the light source 22 may be projected through the filter to create a logo or symbol L to be projected, for example, onto the ceiling C of a garage structure such as illustrated in FIG. 2a.

The controller 20 may be a computing device such as a dedicated microprocessor or electronic control unit (ECU) operating in accordance with instructions from appropriate control software. Thus, the controller 20 may comprise one or more processors, one or more memories and one or more network interfaces that all communicate with each other over a communication bus. In the illustrated embodiment, the controller 20 is connected via a control line 26 to a transceiver 28 and via control line 30 to an ambient light sensor 32.

The cell phone 18 may include an app for activating the system 10. For example, the app may create a button 34 on the touchscreen 36. When the button 34 is depressed, a wireless operator identification signal 38 is sent from the cell phone 18 to the transceiver 28. Upon receipt of the operator identification signal 38, the transceiver 28 sends a signal along control line 26 to the controller 20 indicating reception of the signal which corresponds to an operator of the motor vehicle V being within a predetermined proximity of the motor vehicle. The controller 20 is then configured to activate the light projector 12 so that the light beacon 14 is projected above the motor vehicle V where it may be easily perceived by the operator thereby allowing the operator to more easily locate the motor vehicle V. This is true whether that motor vehicle V is outside in a crowded parking lot such as illustrated in FIG. 2b or within a crowded parking garage such as illustrated in FIG. 2a.

In the illustrated embodiment the key fob 16 includes four buttons 40, 42, 44, 46. The first button 40 may comprise a dedicated actuator for activating the system 10. The second button 42 may comprise a remote start actuator for remote starting of the motor vehicle V. The third button 44 may comprise a door unlock actuator for unlocking the doors of the motor vehicle V. The fourth button 46 may comprise an actuator for locking the doors of the motor vehicle V.

The key fob 16 may include a controller 48 connected to a transmitter 50. The controller 48 may be configured to direct the transmitter 50 to transmit a wireless operator identification signal 52 to the transceiver 28 whenever any one or more of the buttons 40, 42, 44, 46 is activated by the motor vehicle operator.

Upon receipt of the wireless operator identification signal 52, the transceiver 28 sends an appropriate signal along the control line 26 to the controller 20. Controller 20 is configured to then activate the light projector 12 to project the light beacon 14 above the motor vehicle V so as to allow the operator to quickly and easily locate the motor vehicle in the manner illustrated in FIGS. 2a and 2b.

In the illustrated embodiment, the controller 20 is also connected to the ambient light sensor 32. In such an embodiment, the controller 20 may be configured to only activate the light projector 12 in response to the receipt of the operator identification signal 38 or 52 when the ambient light levels are below a predetermined threshold level at which the light beacon 14 is readily visible.

As should be appreciated, the light beacon 14 emitted by the light projector may take substantially any desired shape including, for example, symbols and company logos. Thus, for example, the light projector 12 may take the shape of one or more letters including, for example, the initials of the motor vehicle owner operator. The light beacon 14 may also assume the shape of the company logo of the motor vehicle manufacturer. In yet another possible embodiment, the light beacon 14 may assume the shape of the logo of the company which owns the motor vehicle. As should be appreciated these are just three limited examples of the possible shapes the light beacon 14 may assume and they should not be considered as limiting in scope. Substantially any other shape may be utilized including stationary or animated shapes in the form of light beams or even projected holographic images. Image customization is also possible.

In this regard it should be appreciated that the light projector 12 may incorporate one or more light sources in order to generate the desired shape of the light beacon 14. Further it should be appreciated that the light projector 12 may be mounted or carried on the motor vehicle in a number of different positions to allow projection of the light beacon 14 in a vertical direction above the motor vehicle. Those positions include, but are not necessarily limited to the roof R of the motor vehicle as illustrated in FIG. 2b, the trunk lid of the motor vehicle, the hood of the motor vehicle, and in the side view mirror housing H of the motor vehicle V as illustrated in FIG. 2a.

Consistent with the above description, a method of locating a motor vehicle V is also provided. That method may be broadly described as including the steps of sensing when an operator of the motor vehicle V is within a predetermined proximity of the motor vehicle and activating, by the controller 20, the light projector 12, when the operator is detected within the predetermined proximity of the motor vehicle. As indicated above, that proximity determination may be made by receipt of the wireless operator identification signal 38 or 52 at the transceiver 28 following transmission from the key fob 16 or the cell phone 18.

The method may also include the projecting of the light beacon 14 above the motor vehicle V when the light projector 12 is activated by the controller 20. As previously indicated, that light beacon 14 may be projected in the form of a symbol or a company logo if desired.

As also apparent from the preceding description, the method may also include the step of sending, by the transmitting device (e.g. the key fob 16 or the cell phone 18) carried by the operator, the operator identification signal 38 or 52 specifically coded to the motor vehicle V.

Still further, the method may include the step of configuring the controller 20 to activate the light projector 12 upon receiving the operator identification signal 38 or 52.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A system for locating a motor vehicle, comprising:
a light projector configured to project a light beacon above said motor vehicle, wherein said light beacon is in a shape of a company logo;
a transmitting device for transmitting an operator identification signal specific to said motor vehicle; and
a controller configured to activate said light projector when an operator of said motor vehicle is within a predetermined proximity of said motor vehicle as indicated by receipt of said operator identification signal specific to said motor vehicle.

2. (canceled)

3. (canceled)

4. The system of claim 1, wherein said transmitting device is a cell phone carried by said operator.

5. The system of claim 1, wherein said transmitting device is a key fob for said motor vehicle.

6. The system of claim 5, wherein said controller is configured to activate said light projector when an actuator on said key fob is activated.

7. The system of claim 6, wherein said actuator is a dedicated actuator for activating said light projector.

8. The system of claim 6, wherein said actuator is a remote start actuator for remote starting of said motor vehicle.

9. The system of claim 6, wherein said actuator is a door unlock actuator for unlocking doors of said motor vehicle.

10. The system of claim 6, wherein said actuator is a door lock actuator for locking doors of said motor vehicle.

11. A system for locating a motor vehicle, comprising:
a light projector configured to project a light beacon above the motor vehicle, said light beacon having a shape of a company logo; and
a controller configured to operate said light projector.

12. A method of locating a motor vehicle, comprising:
sensing when an operator of said motor vehicle is within a predetermined proximity of said motor vehicle;
activating, by a controller, a light projector when said operator is detected within said predetermined proximity of said motor vehicle; and
projecting, by said light projector, a light beacon in a form of a company logo above said motor vehicle when activated by said controller.

13. (canceled)

14. (canceled)

15. (canceled)

16. The method of claim 12, including sending, by transmitting device carried by said operator, an operator identification signal specific to said motor vehicle.

17. The method of claim 16, including sending said operator identification signal from a key fob.

18. The method of claim 17, including configuring said controller to activate said light projector upon receiving said operation identification signal.

19. The method of claim 16, including sending said operator identification signal from a cell phone of said operator.

20. The method of claim 19, including configuring said controller to activate said light projector upon receiving said operator identification signal.
